(19) United States
(12) Patent Application Publication
(10) Pub. No.: US 2010/0066204 A1
(43) Pub. Date: Mar. 18, 2010

(54) PIEZOELECTRIC TRANSFORMER DRIVING CIRCUIT

(76) Inventors: Yuji Hayashi, Saitama (JP); Akira Mizutani, Saitama (JP)

Correspondence Address: SNELL & WILMER LLP (OC), 600 ANTON BOULEVARD, SUITE 1400, COSTA MESA, CA, 92626, US

(21) Appl. No.: 12/513,162

(22) PCT Filed: Oct. 24, 2007
(86) PCT No.: PCT/JP2007/001157

§ 371 Date: Jul. 9, 2009

(30) Foreign Application Priority Data
Nov. 7, 2006 (JP) 2006-301635

(51) Int. Cl. H02N 2/06

(52) U.S. Cl. 310/318

(57) ABSTRACT

A piezoelectric transformer driving circuit is provided which reduces switching losses in a full bridge circuit which drives a piezoelectric transformer.

The piezoelectric transformer driving circuit has a full bridge circuit 1 comprising four FETs (field effect transistors) Q1 to Q4, a driving circuit 2 thereof, a filter circuit 3 which converts a square wave output from the full bridge circuit 1 into a sinusoidal wave, and one or a plurality of piezoelectric transformers 4 connected to the filter circuit 3. A cold cathode tube 5 serving as a backlight is connected to the secondary terminals of each of the piezoelectric transformers 4. In the filter circuit 3, an inductance L1 to adjust the current phase of the full bridge load is connected in parallel with the output of the full bridge 1 or the piezoelectric transformers 4. The load impedance of the full bridge circuit 1 becomes inductive, and the phase of the output current of the full bridge circuit 1 becomes a lagging phase, so that through currents do not flow.

### TECHNICAL FIELD

This invention relates to a piezoelectric transformer driving circuit used as backlight inverters in the displays of personal computers and in liquid crystal televisions, and in particular relates to a piezoelectric transformer driving circuit in which the switching loss of the full bridge circuit which drives the piezoelectric transformer is reduced.

### BACKGROUND ART

Piezoelectric inverters used as backlight inverters in notebook computers and other applications can utilize the frequency characteristics (resonance characteristics) of piezoelectric transformers to change the driving frequency, in order to control the output current. Hence even when the input voltage is changed, by enabling changes in the driving frequency, input fluctuations can be absorbed and a constant output current can be maintained.

However, the conversion efficiency of a piezoelectric transformer is maximum in a specific region near a resonance point, and upon deviating from this region the conversion efficiency gradually falls; thus if the input voltage changes, the frequency is changed correspondingly, deviating from the frequency range in which the maximum efficiency of the piezoelectric transformer is obtained, and lowering the inverter efficiency. Hence in a backlight inverter using a piezoelectric transformer, changes in the input voltage must be controlled in a stage preceding the piezoelectric transformer, in order to input a constant voltage to the piezoelectric transformer.

This requirement has led to proposals of inverter circuits such as those disclosed in Patent Reference 1 and Patent Reference 2. In this technology of the prior art, the duty of a full bridge circuit (full-wave bridge circuit) having a pair of switches is controlled to vary the output voltage, so that even when the input voltage is changed the voltage applied to the piezoelectric transformer is held constant.

As shown in FIG. 4, a piezoelectric transformer driving circuit employing such a full bridge circuit comprises a full bridge circuit 1 comprising four FETs (field effect transistors) Q1 to Q4 (hereafter abbreviated Q1 to Q4); a driving circuit 2 for the full bridge circuit 1; a filter circuit 3, which converts the square wave output from the full bridge circuit 1 into a sinusoidal wave; and one or a plurality of piezoelectric transformers 4, connected to this filter circuit 3. The secondary terminals of each of the piezoelectric transformers 4 are connected to a cold cathode tube 5 which serves as the backlight. The full bridge circuit 1 is connected to an input voltage supply, not shown.

FIG. 5 shows the relation between the on/off states of each of Q1 to Q4, driven by the driving circuit 2, and the output voltage waveform when, as one example, the output voltage is ±400 V. As is clear from FIG. 5, when Q1 and Q4 are turned on +400 V is output, when Q3 and Q4 are turned on 0 V is output, and when Q2 and Q3 are turned on −400 V is output.

This full bridge circuit 1 is provided with a dead time to prevent even momentarily the turning-on of both FETs (simultaneously turning-on of Q1 and Q3, or of Q2 and Q4) with the timing at which each of the FETs is turned on and off; control is executed such that all FETs are turned off other than those which are turned on around the time of the switching.

Further, in Patent Reference 2, it is proposed that functions similar to this dead time be provided by providing simultaneous turn-on prevention means, comprising first and second resistances and a diode, at the gate of each FET.

Patent Reference 1: Japanese Patent Application Laid-open No. 2002-233158

Patent Reference 2: Japanese Patent Application Laid-open No. 2003-164163

However, in conventional technology which provides dead time such as described above, and in conventional technology which provides simultaneous turn-on prevention means as in Patent Reference 2, the through currents occurring due to body diodes which are parasitic on each FET cannot be prevented, and so switching losses occurring as a result could not be avoided. Below, the problem of through currents arising from body diodes is discussed in detail.

In general, for structural reasons a diode is connectedⁱ in parallel to a FET in the direction of flow of current from source to drain, that is, with the source and anode connected and the drain and cathode connected. This diode is called a parasitic diode or a body diode; because of the presence of this diode, the FET is used as a switching element to pass or stop current in the direction from drain to source. ⁱ“A diode is connected” sounds like a discrete diode component is intentionally connected to the FET; perhaps “a diode appears” or “a diode is formed to ensure stable operation” is preferable (see http://en.wikipedia.org/wiki/Power_MOSFET#Body_diode).

Due to the characteristics of this body diode, when the FET gate voltage is at 0 V and the FET is turned off, during the recovery time Δt, a reverse bias current flows. Consequently in FETs used to form a full bridge circuit, a through current flows at the time of switching in switching operation, and causes increases in switching losses.

This is explained more specifically in FIG. 6. FIG. 6 shows a state of conduction of Q1 to Q4 for a case in which, in the above FIG. 5, the output voltage changes from the 0 V state 3 to the dead time state 4, and then to the −400 V state 5. In this case, the full bridge load 6 is assumed to be capacitive.

In state 4 on the left-hand side of FIG. 6, the change from state 3 in the FETs is off→off for Q1, off→off for Q2, constantly on for Q3, and on→off for Q4; because the body diode D4 of Q4 is conducting, a circulating current flows, body diode D4→full bridge load 6→Q3.

Upon the transition from this dead time state 4 to the −400 V state 5, immediately before the off→on transition (in state 4) of Q2, which is to be turned on in state 5, the body diode D4 of Q4 is conducting, so that during the recovery time Δt, the body diode D4 is in the conducting state due to the reverse bias current.

As a result, at the beginning of state 5 when Q2 is turned on, a through current Q2→body diode D4 flows, as indicated by the dashed line on the right-hand side in FIG. 6; on the other hand, −400 V is applied to the full bridge load 6 by the route Q2→full bridge load 6→Q3. At this time, the current flowing in the load is flowing with the same polarity as the voltage applied to the load. This is because the load impedance is capacitive, so that the current phase leads the voltage phase.

Because this phenomenon continues for the duration of the recovery time of the body diode D4, during this period switching is not performed, resulting in a switching loss. This phenomenon does not occur solely for Q4 in FIG. 6, but occurs similarly for the other FETs as well.

For Q1 and Q2, the conditions for occurrence of a through current upon this off→on transition is that a current be flowing in the forward direction in the diode of the FET in which a through current is possible. In other words, immediately before turning on, when the current flowing in the load is a forward-direction current for the FET (the voltage applied to the load and the direction of the current flowing are the same positive direction), that is, when the phase of the current flowing in the load leads the phase of the full bridge output voltage, a through current occurs. Similar remarks apply for Q3 and Q4 as well.

The relations between the occurrence of these through currents, voltage and current directions, and the duty of the full bridge circuit are explained in detail using FIG. 7, which shows the case of Q1 and Q2, and FIG. 8, which shows the case of Q3 and Q4.

That is, FIG. 7 and FIG. 8 show the relation between the output voltage of the full bridge circuit 1 and the fundamental component of the current flowing in the load, when the duty of the full bridge circuit 1 is D=1−2φ/π, and the angle of the impedance of the full bridge circuit 1 is θ.

In FIG. 7, showing the case of Q1 and Q2, when the directions of the voltage and current are (a), the condition under which a through current does not flow is

π/2+φ≦π/2+θ (1)

Because D=1−2φ/π, φ=π(1−D)/2, and substitution into equation (1) gives the following relation between the duty D and θ.

D≧−2θ/π+1

FIG. 9 is a graph of the relation between this duty D and the load impedance θ; in the figure, through currents do not flow in regions denoted “OK”. As can be seen from FIG. 9, when the load impedance angle θ<0, flowing of through currents is always possible.

On the other hand, in FIG. 8 showing the case of Q3 and Q4, when the voltage and current directions are (b), the condition under which a through current does not flow is

π/2−φ≦π/2+θ (2)

Because D=1−2φ/π, φ=π(1−D)/2, and substitution of this into equation (2) gives the following relation for the duty D and θ.

D≦−2θ/π+1

FIG. 10 is a graph of the relation between this duty D and the load impedance θ; in the figure, through currents do not flow in regions denoted “OK”. As can be seen from FIG. 10, when the load impedance is inductive (θ≧0), no through currents flow, regardless of the duty value; but when the load impedance is capacitive (θ<0), there is a constraint on the duty.

As one example, when the maximum duty D=0.8, if the load impedance angle θ is such that +90°≧θ<−20°, through currents do not flow.

In FIG. 11, changes in the output current of the full bridge circuit 1 due to the presence of a through current are shown. In the regions with no through currents, denoted OK in FIG. 9 and FIG. 10, a current with polarity opposite that of the voltage flows, as shown in (a) of FIG. 11, whereas in regions in which through currents flow, beyond (b) in FIG. 11 which is the limiting condition for through currents, a current with the same polarity as the voltage flows, as indicated in (c) of FIG. 11. This fact means that because the current phase leads and the load is capacitive, a forward current flows in the body diode, and consequently a through current flows.

As explained above, when the load impedance angle θ≧0 and the load is inductive, no through current flows in any of Q1, Q2, Q3 or Q4, but when the load is capacitive, the occurrence of through currents cannot be avoided.

### DISCLOSURE OF THE INVENTION

This invention was proposed in order to resolve the above problem of the prior art, and has as an object the provision of a piezoelectric transformer driving circuit, in the body diodes of which reverse bias currents do not flow during FET on/off switching, and which enables reduction of switching losses arising from through currents.

In order to attain the above object, a piezoelectric transformer driving circuit of this invention, which applies to a piezoelectric transformer an output of a switching circuit comprising a plurality of FETs connected to an input voltage supply, and causes a load to operate by means of an output of this piezoelectric transformer, is characterized in that an inductance is inserted in parallel with the switching circuit or the piezoelectric transformer, and that the load impedance of the switching circuit is made inductive by means of this inductance. In this case, as the switching circuit, a full bridge circuit can be used.

Another mode of the invention is characterized in that a filter circuit which shapes high harmonic components of a square wave output from the switching circuit into a substantially sinusoidal shape is provided between the switching circuit and the piezoelectric transformer, and in that an inductance is inserted into a portion of this filter circuit, in parallel with the switching circuit or with the piezoelectric transformer.

In this case, it is desirable that the inductance be inserted in the filter circuit such that, at least in a frequency band used in shaping the output waveform of high harmonic components from the switching circuit, an input impedance angle θ be greater than 0.

In a piezoelectric transformer driving circuit of the invention having such a configuration, by inserting an inductance on the input side of the piezoelectric transformer, the full bridge circuit load impedance can be made inductive, and the phase of the full bridge load current can be made a “lagging phase”. As a result, the occurrence of through currents arising in the case of a leading phase can be prevented.

According to this invention, by means of a simple configuration in which an inductance is inserted on the input side of the piezoelectric transformer, the occurrence of through currents arising due to reverse bias currents flowing in the body diodes of FETs can be prevented, and FET switching losses can be reduced.

### BRIEF DESCRIPTION OF THE DRAWINGS

FIG. 1 is a block diagram showing the configuration of a first aspect of the invention;

FIG. 2 is a graph showing the characteristics of the first aspect and of a low-pass filter in the prior art;

FIG. 3 is a circuit diagram showing conduction states for Q1 to Q4 when, in the first aspect, there is a change from an output voltage 0 V state 3 to a dead time state 4, and then to a −400 V state 5;

FIG. 4 is a block diagram showing an example of a driving circuit of a format of the prior art;

FIG. 5 is a graph showing the relation between the on/off states for each FET and the full bridge circuit output voltage in technology of the prior art;

FIG. 6 is a circuit diagram showing conduction states for Q1 to Q4, when the output voltage changes from the 0 V state 3 to the dead time state 4 and then to a −400 V state 5;

FIG. 7 is a graph showing the voltage and load impedance angle, to explain the conditions in which through currents do not flow in Q1 or Q2;

FIG. 8 is a graph showing the voltage and load impedance angle, to explain the conditions in which through currents do not flow in Q3 or Q4;

FIG. 9 is a graph showing the relation between duty and load impedance angle at which through currents do not flow in Q1 or Q2;

FIG. 10 is a graph showing the relation between duty and load impedance angle at which through currents do not flow in Q3 or Q4; and,

FIG. 11 is a graph showing the change in the full bridge circuit output current due to the presence of through currents.

### EXPLANATION OF REFERENCE NUMERALS

1 FULL BRIDGE CIRCUIT

2 DRIVING CIRCUIT

3 FILTER CIRCUIT

4 PIEZOELECTRIC TRANSFORMER

5 COLD CATHODE TUBE

6 FULL BRIDGE LOAD

L1 INDUCTANCE

### BEST MODE FOR CARRYING OUT THE INVENTION

(1) First Aspect

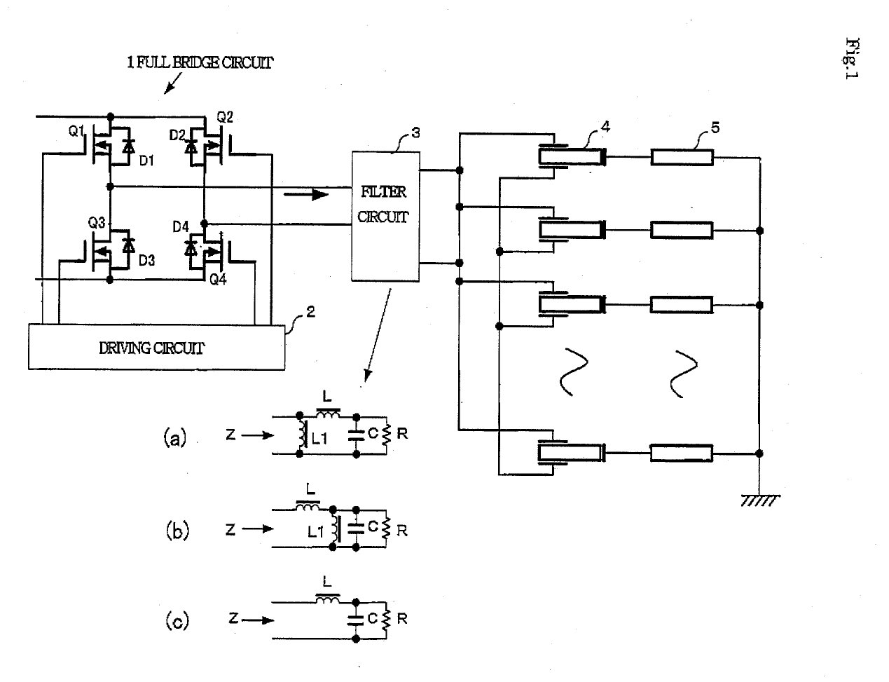

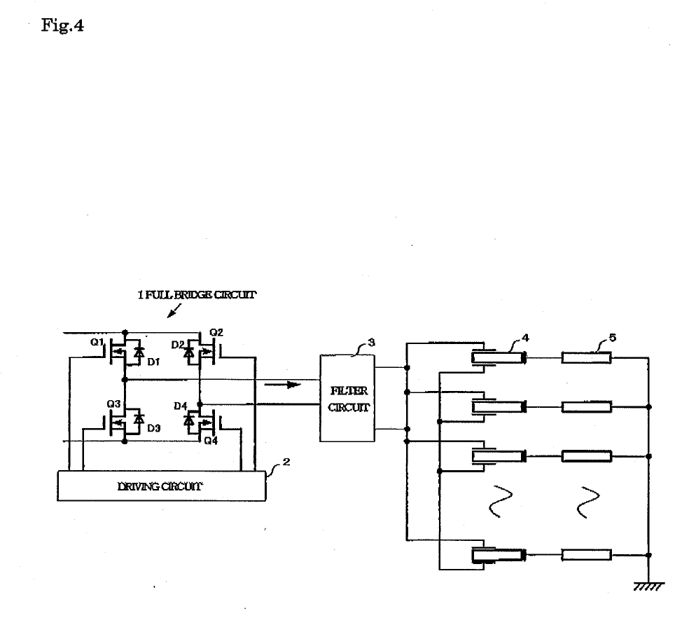

Below, a first aspect of the invention is explained in detail referring to FIG. 1. In FIG. 1, portions with the same configuration as shown in FIG. 4 are assigned the same symbols, and explanations are omitted.

The filter circuit 3 connected on the output side of the full bridge circuit 1 in FIG. 1 comprises a low-pass filter having a resonance circuit formed from a capacitor C, inductance L, and load R, as shown in the equivalent circuit. In this case, the capacitance C comprises the primary-side capacitance of the piezoelectric transformer 4, and the inductance L comprises an externally mounted inductance.

In this aspect, as the filter circuit 3, an inductance L1 for adjustment of the current phase of the full bridge load is connected in parallel with the full bridge circuit 1 or with the piezoelectric transformer 4, as shown in (a) or (b) of the equivalent circuit.

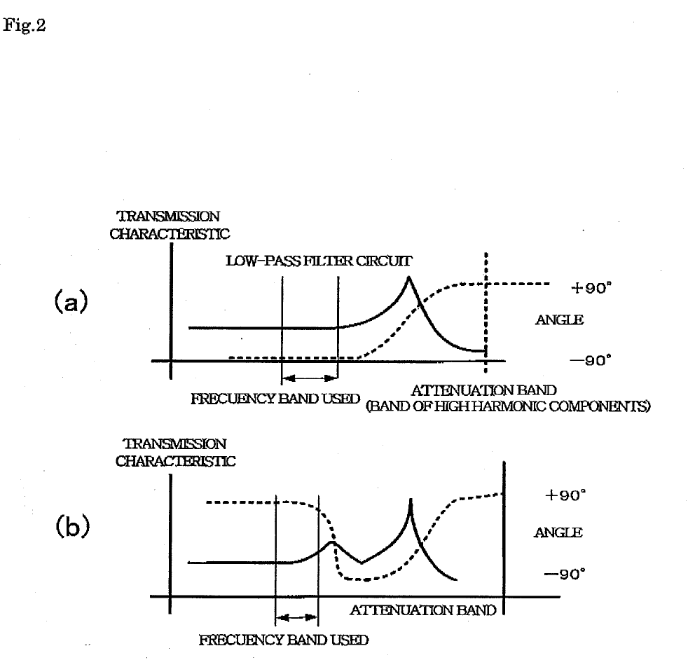

The action of a filter circuit 3 having such a configuration is as follows. The equivalent circuit of a conventional low-pass filter not having an inductance L1 for current phase adjustment is as shown in (c), and the transmission characteristic and frequency characteristic thereof are as shown in (a) of FIG. 2.

In this conventional low-pass filter, in the frequency band used as the attenuation band for high harmonic components applied to the piezoelectric transformer 4, the input impedance angle is close to −90°, and the load impedance of the full bridge circuit 1 can be said to be capacitive. When the load impedance of a full bridge circuit 1 in the prior art is capacitive, the phase of the output current of the full bridge circuit 1 is a “leading phase”.

On the other hand, as shown in (b) of FIG. 2, the characteristic of a low-pass filter connected with an inductance L1 in parallel to a full bridge output or a piezoelectric transformer 4 as in this aspect is such that, in the frequency band used, the input impedance angle is close to +90°, so that the load impedance of the full bridge circuit 1 is inductive, and the output current phase of the full bridge circuit 1 is a “lagging phase”.

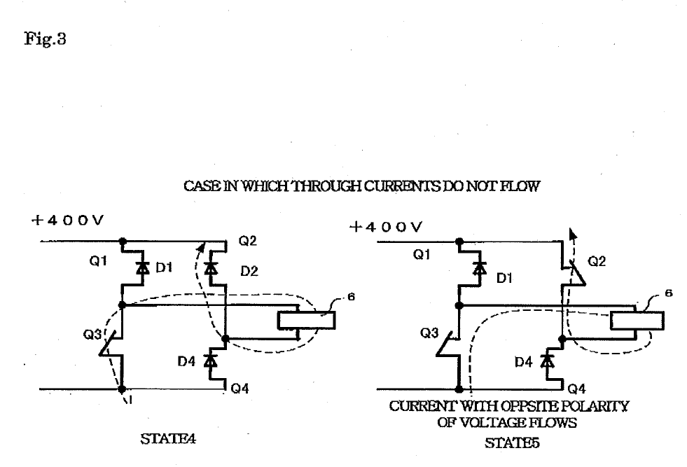

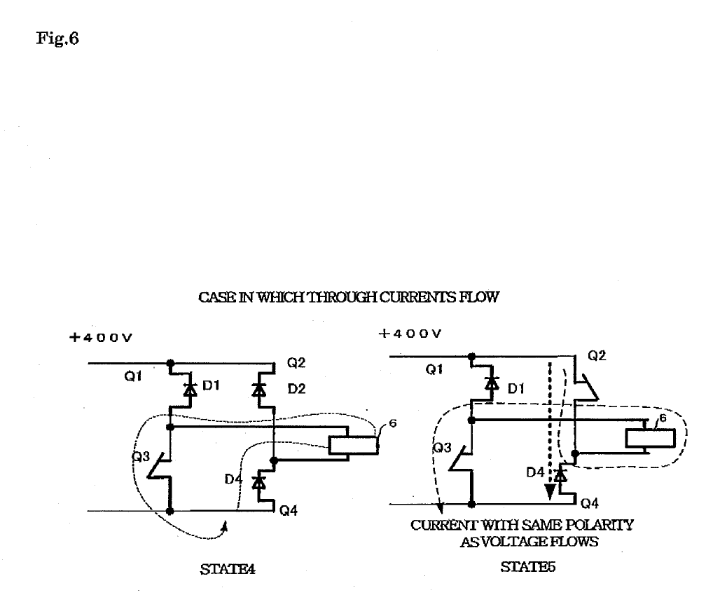

Current paths in a state in which current does not flow in a FET which has been turned off during the dead time in this way are explained referring to FIG. 3. FIG. 3 corresponds to states 4 and 5 in FIG. 6, in which through current flows.

In FIG. 3, when Q4 has transitioned from state 3 at 0 V to state 4 during the dead time, because the output current has a lagging phase, the body diode D4 is not conducting in the forward direction. As a result, current flows in the order Q3→full bridge load 6→body diode D2 of Q2 in the off state (forward-direction current).

When the dead time has elapsed and a transition is made to state 5, the terminals of the body diode D2 which had not been conducting are turned on by Q2, current flows in the order Q3→full, bridge load 6→Q2 in the on state without a change in current path, and current with polarity opposite the voltage flows in the full bridge load 6. In this way, by means of this aspect, switching is performed without undue difficulty, so that switching losses can be reduced.

(2) Other Aspects

This invention is not limited to the configuration of the first aspect, and another configuration can be adopted, so long as the flow of current in the body diode of an FET which has transitioned from on to off is limited during the dead time.

That is, in the first aspect, by inserting the inductance L1 in the filter circuit 3 provided after the full bridge circuit 1, the load was made inductive; but an inductance may be provided on the output side of the full bridge circuit, entirely separately from the filter circuit 3.

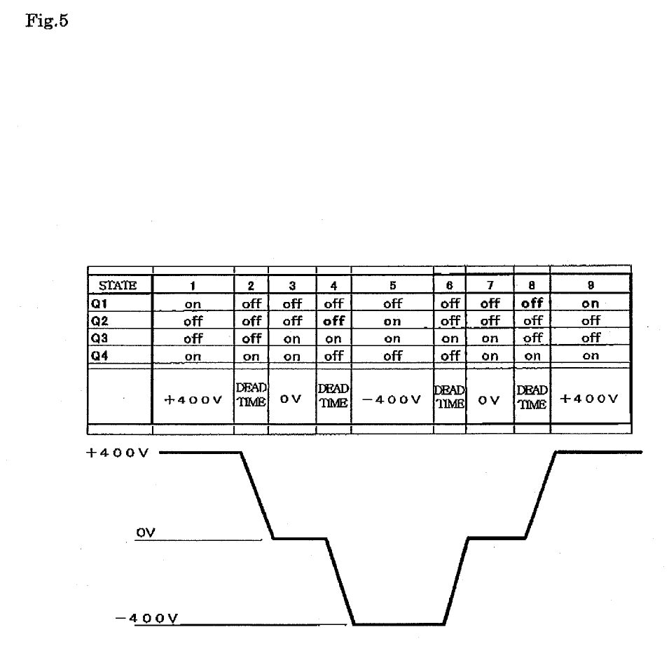

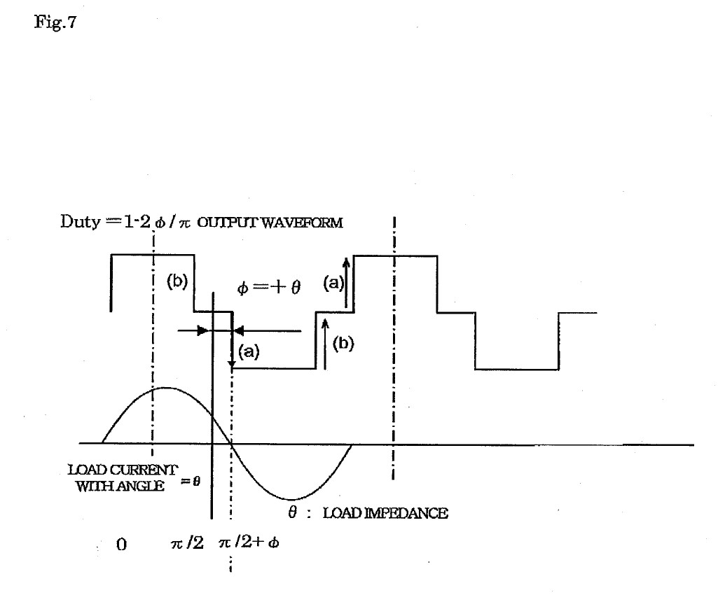

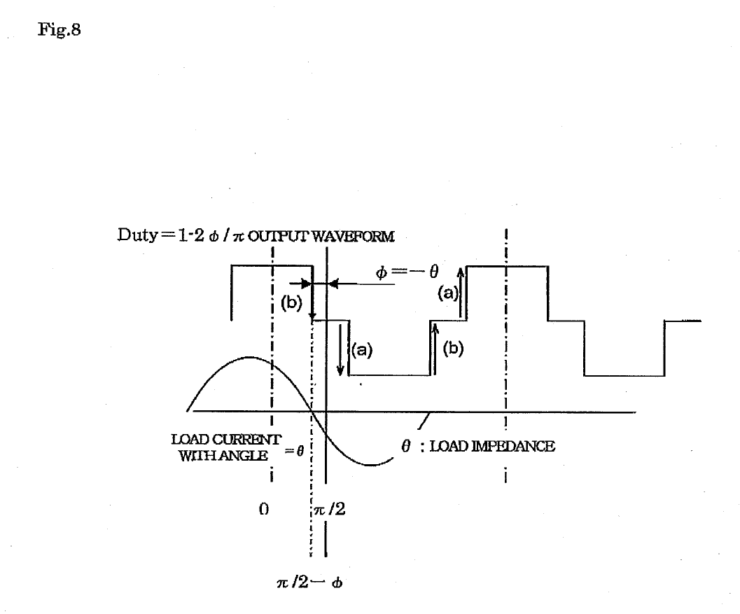

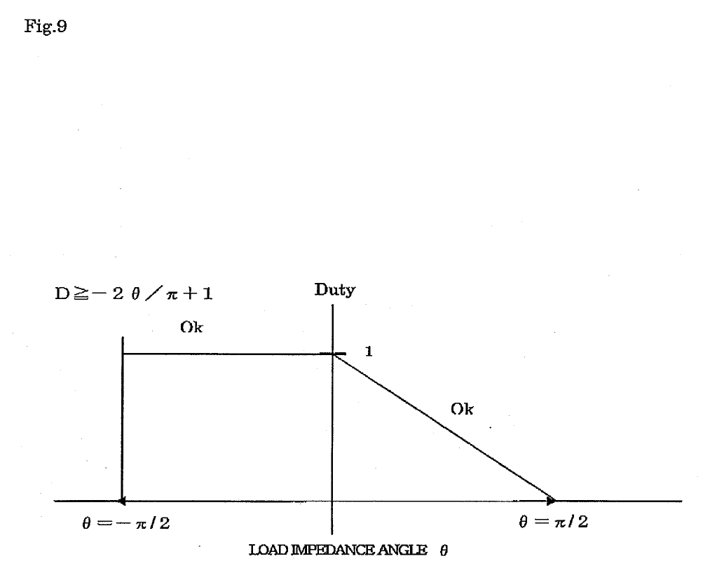

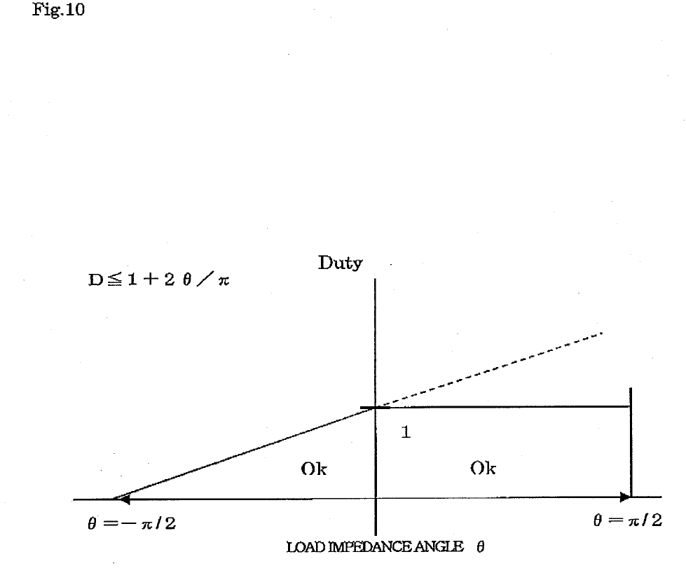

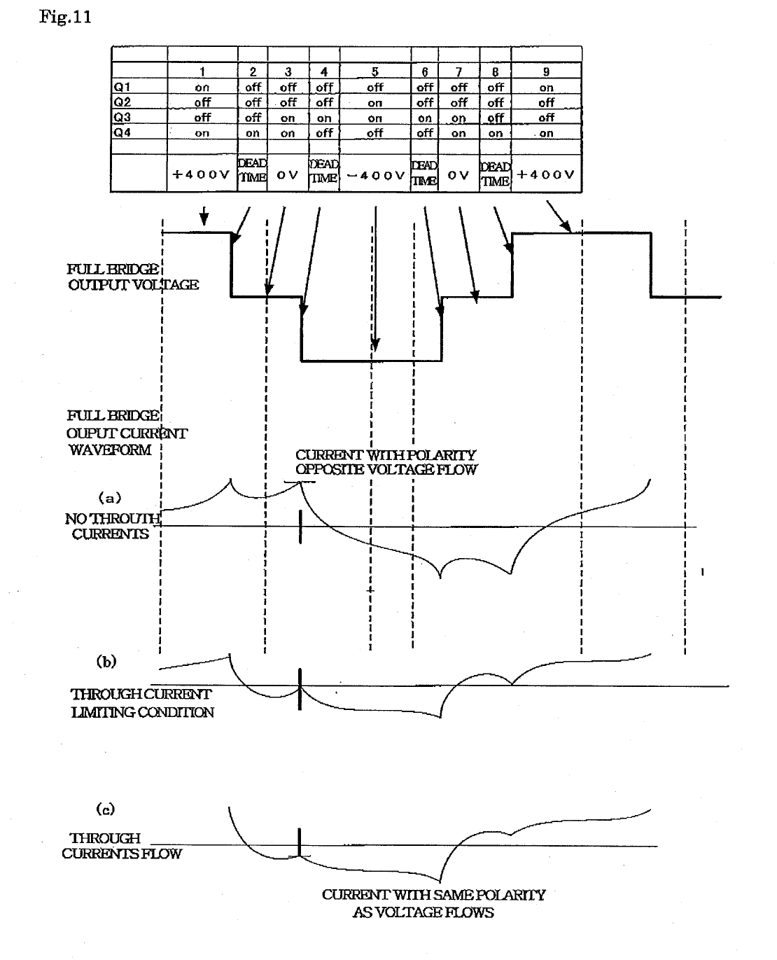

Further, the first aspect relates to a full bridge circuit; but this invention can also be applied to cases in which through currents occur due to the body diodes of FETs in piezoelectric inverter driving circuits employing half bridge circuits or other switching circuits.
FIG. 1
1 FULL BRIDGE CIRCUIT
2 DRIVING CIRCUIT
3 FILTER CIRCUIT
FIG. 2
(A)
TRANSMISSION CHARACTERISTIC
LOW-PASS FILTER CIRCUIT
ANGLE
FREQUENCY BAND USED
ATTENUATION BAND (BAND OF HIGH HARMONIC COMPONENTS)
(B)
TRANSMISSION CHARACTERISTIC
ANGLE
FREQUENCY BAND USED
ATTENUATION BAND
FIG. 3
CASE IN WHICH THROUGH CURRENTS DO NOT FLOW
STATE 4
STATE 5
CURRENT WITH OPPOSITE POLARITY OF VOLTAGE FLOWS
FIG. 4
1 FULL BRIDGE CIRCUIT
2 DRIVING CIRCUIT
3 FILTER CIRCUIT
FIG. 5
STATE
DEAD TIME
DEAD TIME
DEAD TIME
DEAD TIME
FIG. 6
CASE IN WHICH THROUGH CURRENTS FLOW
STATE 4
STATE 5
CURRENT WITH SAME POLARITY AS VOLTAGE FLOWS
FIG. 7
DUTY=1−2φ/π OUTPUT WAVEFORM
LOAD CURRENT WITH ANGLE=θ
θ: LOAD IMPEDANCE
FIG. 8
DUTY=1−2φ/π OUTPUT WAVEFORM
LOAD CURRENT WITH ANGLE=θ
θ: LOAD IMPEDANCE
FIG. 9
LOAD IMPEDANCE ANGLE θ
FIG. 10
LOAD IMPEDANCE ANGLE θ
FIG. 11
DEAD TIME
DEAD TIME
DEAD TIME
DEAD TIME
FULL BRIDGE OUTPUT VOLTAGE
FULL BRIDGE OUTPUT CURRENT WAVEFORM
(a) NO THROUGH CURRENTS
(b) THROUGH CURRENT LIMITING CONDITION
(a) THROUGH CURRENTS FLOW
CURRENT WITH POLARITY OPPOSITE VOLTAGE FLOWS
CURRENT WITH SAME POLARITY AS VOLTAGE FLOWS

1. A piezoelectric transformer driving circuit, which applies to a piezoelectric transformer an output of a switching circuit comprising a plurality of FETs connected to an input voltage supply, and causes a load to operate by means of an output of this piezoelectric transformer, characterized in that
an inductance is inserted in parallel with the switching circuit or piezoelectric transformer, and the load impedance of the switching circuit is made inductive by means of this inductance.

2. The piezoelectric transformer driving circuit according to claim 1, wherein the switching circuit is a full bridge circuit.

3. The piezoelectric transformer driving circuit according to claim 1, characterized in that a filter circuit, which shapes high harmonic components of a square wave output from the switching circuit into a substantially sinusoidal shape, is provided between the switching circuit and piezoelectric transformer, and in that an inductance is inserted into a portion of this filter circuit, in parallel with the switching circuit or piezoelectric transformer.

4. The piezoelectric transformer driving circuit according to claim 3, characterized in that the inductance is inserted in the filter circuit such that, at least in a frequency band used in shaping the output waveform of high harmonic components from the switching circuit, an input impedance angle θ is greater than 0.

5. The piezoelectric transformer driving circuit according to claim 1, characterized in that the switching circuit has a dead time at the time of switching of the plurality of FETs, and switches a FET in an on state prior to the dead time to an off state with the dead time intervening, and during the dead time, forward-direction current is not passed on a body diode of the FET in the off state.

6. The piezoelectric transformer driving circuit according to claim 5, characterized in that, among the plurality of FETs, by passing current in body diodes of other FETs which are off during the dead time, current is passed in a path that avoids the FETs which are in the on state prior to the dead time and which are in the off state after the dead time.
